(19) United States
(12) Patent Application Publication
(10) Pub. No.: US 2026/0278874 A1
(43) Pub. Date: Sep. 17, 2026

(54) FACE ENCODER INCLUDING TOKEN FUSION MODEL

(71) Applicant: Bytedance Technology Ltd., Grand Cayman (KY)

(72) Inventors: Zichuan LIU, Los Angeles, CA (US); Qing YAN, Los Angeles, CA (US); Xin LU, Los Angeles, CA (US); Liming JIANG, Los Angeles, CA (US); Yumin JIA, Los Angeles, CA (US); Hao KANG, Los Angeles, CA (US); Efstathios FOTIADIS, Los Angeles, CA (US)

(21) Appl. No.: 19/090,249

(22) Filed: Mar. 25, 2025

(30) Foreign Application Priority Data
Mar. 16, 2025 (GR) 20250100187

(51) Int. Cl. G06T 11/60; G06F 40/40; G06V 10/774; G06V 40/16

(52) U.S. Cl. CPC G06T 11/60; G06F 40/40; G06V 10/774; G06V 40/168

(57) ABSTRACT

A computing system including one or more processing devices configured to execute a face encoder including a text encoder, a face extraction model, and a token fusion model. At the face encoder, the one or more processing devices receive a text prompt and receive an input image depicting a face. At the text encoder, the one or more processing devices compute a text token sequence based at least on the text prompt. At the face extraction model, the one or more processing devices compute a face patch token sequence that encodes the face. At the token fusion model, the one or more processing devices compute a multimodal token sequence based at least on the text token sequence and the face patch token sequence. At a pretrained diffusion model, the one or more processing devices compute and output an output image conditioned on the multimodal token sequence.

### CROSS-REFERENCE TO RELATED APPLICATION(S)

This application claims priority to Greek application No. 20250100187 filed on Mar. 16, 2025, the disclosure of which is incorporated herein by reference in its entirety.

### BACKGROUND

Text-to-image (T2I) models have greatly increased in usage in recent years as machine learning (ML) model capabilities have advanced. A T2I model receives a text input and generates a corresponding output image that reflects a description provided in the text input. Thus, a user of the T2I model uses the text input to control the contents and style of the generated output image.

Some T2I models also receive a reference image as an input in addition to the text input. When a T2I model processes the reference image, the T2I model generates an output image that includes attributes of the reference image, such as one or more stylistic features and/or depicted subjects. As in T2I generation without a reference image, a T2I model that makes use of a reference image also conditions the generation of the output image on the text input. The user may accordingly use both text and image inputs to control output image generation at the T2I model.

### SUMMARY

According to one aspect of the present disclosure, a computing system is provided, including one or more processing devices configured to execute a face encoder including a text encoder, a face extraction model, and a token fusion model. At the face encoder, the one or more processing devices are configured to receive a text prompt and receive an input image depicting a face. At the text encoder, the one or more processing devices are further configured to compute a text token sequence based at least in part on the text prompt. At the face extraction model, the one or more processing devices are further configured to compute a face patch token sequence that encodes the face depicted in the input image. At the token fusion model, the one or more processing devices are further configured to compute a multimodal token sequence based at least in part on the text token sequence and the face patch token sequence. At a pretrained diffusion model, the one or more processing devices are further configured to compute an output image conditioned on the multimodal token sequence. The one or more processing devices are further configured to output the output image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing system at which a face encoder and a pretrained diffusion model are executed, according to one example embodiment.

FIG. 2 schematically shows a token fusion model included in the face encoder, according to the example of FIG. 1.

FIG. 3 schematically shows a multi-head attention block included in the token fusion model, according to the example of FIG. 2.

FIGS. 4A-4B schematically show the computing system during training of the face encoder, according to the example of FIG. 1.

FIG. 5A shows a flowchart of a method for use with a computing system to perform image-conditioned T2I generation, according to the example of FIG. 1.

FIGS. 5B-5G show additional steps of the method of FIG. 5A that may be performed in some examples.

FIG. 6 shows a schematic view of an example computing environment in which the computing system of FIG. 1 may be instantiated.

### DETAILED DESCRIPTION

In many instances in which T2I generation is performed using a reference image as an additional input, the reference image depicts the face of the user or another subject. For example, using the text input, the user may instruct a T2I model to change the facial expression or body pose of the subject shown in the reference image, to place the depicted subject into a different background, to modify an outfit worn by the depicted subject, or generate an output image that makes some other modification to the depicted subject's appearance.

The user who prompts the T2I model typically intends for the subject depicted in the output image to be recognizable as the subject depicted in the reference image. However, existing T2I models often fail to preserve recognizability of the depicted subject. Properties specified in the text prompt may, for example, lead existing T2I models to generate output images that alter the depicted subject's facial features in a manner that makes the face depicted in the output image appear to be a different individual compared to the subject depicted in the reference image.

On the flipside, existing techniques of preserving facial recognizability in image-conditioned T2I generation may interfere with prompt adherence. For example, existing facial appearance preservation techniques may prevent the text input from controlling features such as facial expression, face orientation, and accessories. Existing T2I models may therefore have a tradeoff between face recognizability and prompt adherence during image-conditioned T2I generation.

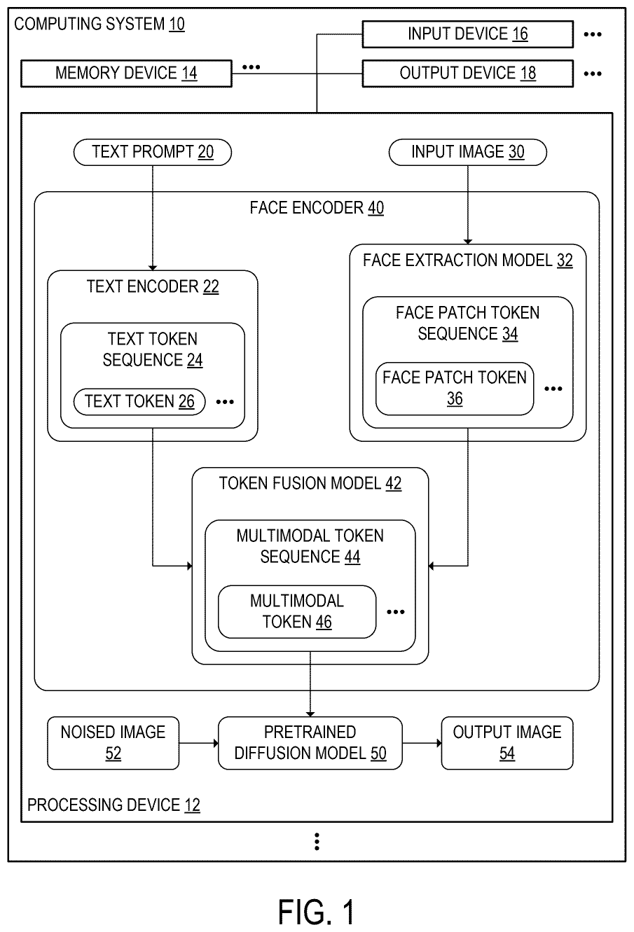

FIG. 1 schematically depicts a computing system 10 configured to address the above challenges. As discussed in further detail below, the computing system 10 is configured to execute a face encoder 40 that conditions the generation of an output image 54 at a pretrained diffusion model 50. The face encoder 40 converts a text prompt 20 and an input image 30 into a multimodal token sequence 44 that is used to control image denoising in a manner that incorporates both the semantic content of the text prompt 20 and the facial features included in the input image 30.

The computing system 10 includes one or more processing devices 12 and one or more memory devices 14. For example, the one or more processing devices 12 may include one or more central processing units (CPUs), graphics processing units (GPUs), and/or neural processing units (NPUs). The one or more memory devices 14 may include volatile memory and/or non-volatile storage. The computing system 10 further includes one or more input devices 16 and one or more output devices 18 via which a user may interact with the computing system 10. The one or more input devices and the one or more output devices 18 may be used to present a graphical user interface (GUI) at which the user may enter the inputs of T2I generation and view the output image 54.

In some examples, the computing system 10 is instantiated across a plurality of physical computing devices. For example, the computing system 10 may have a server-client configuration in which the inputs and outputs of the T2I generation pipeline are client-facing and intermediate stages of the T2I generation pipeline are offloaded to a server computing device. In the server-client configuration, the output image 54 may also be distributed for display at a plurality of different client devices.

FIG. 1 depicts the face encoder 40 during inferencing. As shown in FIG. 1, the one or more processing devices 12 are configured to receive a text prompt 20 and an input image 30 at a face encoder 40. The input image 30 depicts a face.

The face encoder 40 includes a text encoder 22, a face extraction model 32, and a token fusion model 42. At the text encoder 22, the one or more processing devices 12 are further configured to compute a text token sequence 24 based at least in part on the text prompt 20. The text token sequence 24 includes one or more text tokens 26.

At the face extraction model 32, the one or more processing devices 12 are further configured to compute a face patch token sequence 34 that encodes the face depicted in the input image 30. The face patch token sequence 34 includes a plurality of face patch tokens 36, which are regions of the input image 30 within which the face is depicted. Thus, the face extraction model 32 is configured to identify the region of the input image 30 that includes the face, and to specify that region as the face patch token sequence 34. In some examples, a vision transformer (ViT) model may be used as the face extraction model 32.

At the token fusion model 42, the one or more processing devices 12 are further configured to compute a multimodal token sequence 44 based at least in part on the text token sequence 24 and the face patch token sequence 34. The multimodal token sequence 44 includes a plurality of multimodal tokens 46 that jointly encode the information included in the text token sequence 24 and the face patch token sequence 34.

At a pretrained diffusion model 50, the one or more processing devices 12 are further configured to compute an output image 54 conditioned on the multimodal token sequence 44. The one or more processing devices 12 may be configured to initialize the output image 54 as a noised image 52 and iteratively perform a plurality of denoising iterations at the pretrained diffusion model 50. The multimodal token sequence 44 is used to guide this denoising process. In some examples, such as image infilling or extension tasks, the noised image 52 also includes one or more clean regions that are left unchanged over the course of the denoising.

The one or more processing devices 12 are further configured to output the output image 54. For example, the output image 54 may be output to a GUI for display using one or more display devices included among the one or more output devices 18.

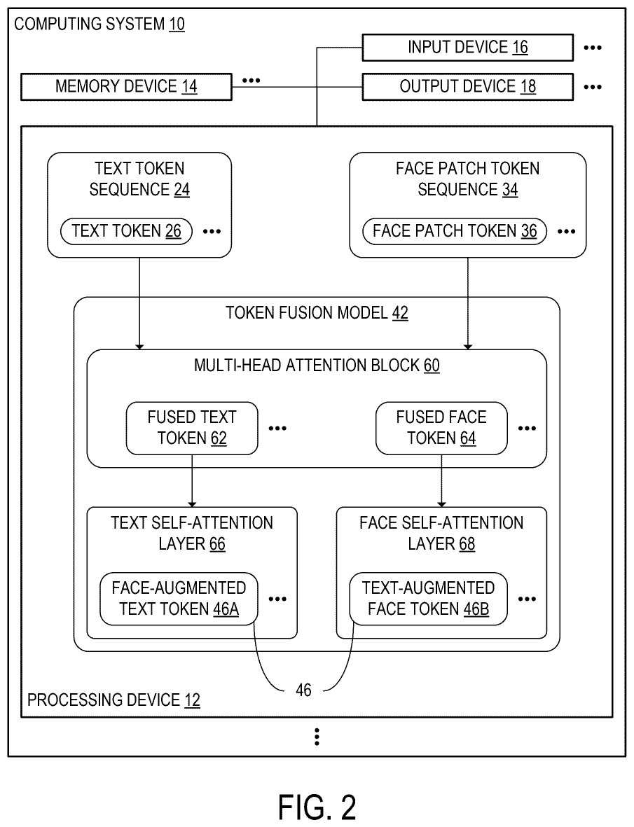

FIG. 2 schematically shows the token fusion model 42 in additional detail. In the example of FIG. 2, the token fusion model 42 includes a multi-head attention block 60, a text self-attention layer 66, and a face self-attention layer 68. At the multi-head attention block 60, the one or more processing devices 12 are further configured to compute a plurality of fused text tokens 62 and a plurality of fused face tokens 64 based at least in part on the text token sequence 24 and the face patch token sequence 34.

The one or more processing devices are further configured to compute the multimodal tokens 46 at the token fusion model 42. At the text self-attention layer 66, the one or more processing devices 12 are further configured to compute a plurality of face-augmented text tokens 46A based at least in part on the fused text tokens 62. At the face self-attention layer 68, the one or more processing devices 12 are configured to compute a plurality of text-augmented face tokens 46B based at least in part on the fused face tokens 64. The multimodal token sequence 44 includes the plurality of face-augmented text tokens 46A and the plurality of text-augmented face tokens 46B. Each of the face-augmented text tokens 46A is a text token 26 concatenated with facial feature data, and each of the text-augmented face tokens 46B is a face patch token 36 concatenated with text feature data, as discussed in further detail below.

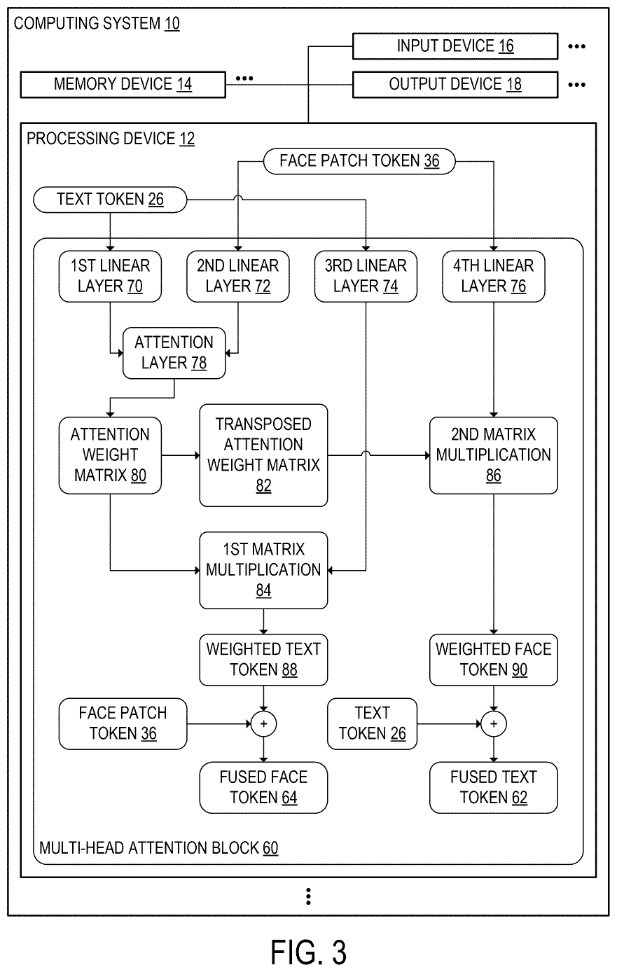

FIG. 3 schematically shows the multi-head attention block 70 in further detail during processing of a text token 26 and a face patch token 36. The multi-head attention block 60 includes a first linear layer 70, a second linear layer 72, a third linear layer 74, and a fourth linear layer 76. The one or more processing devices 12 are configured to input the text token 26 into the first linear layer 70 and the third linear layer 74 and are further configured to input the face patch token 36 into the second linear layer 72 and the fourth linear layer 76.

The multi-head attention block 70 further includes an attention layer 78. The attention layer 78 receives respective outputs of the first linear layer 70 and the second linear layer 72 and computes an attention weight matrix 80. The one or more processing devices 12 are further configured to compute a transposed attention weight matrix 82 by transposing the attention weight matrix 80.

The one or more processing devices 12 are further configured to perform a first matrix multiplication 84 between the attention weight matrix 80 and the output of the third linear layer 74. By performing the first matrix multiplication 84, the one or more processing devices 12 are configured to compute a weighted text token 88. In addition, the one or more processing devices 12 are further configured to perform a second matrix multiplication 86 between the transposed attention weight matrix 82 and the output of the fourth linear layer 76. By performing the second matrix multiplication 86, the one or more processing devices 12 are configured to compute a weighted face token 90.

The one or more processing devices 12 are further configured to concatenate the weighted text token 88 with a corresponding face patch token 36 to obtain the fused face token 64. In addition, the one or more processing devices 12 are further configured to concatenate the weighted face token 90 with a corresponding text token 26 to obtain the fused text token 62. In this manner, the one or more processing devices 12 may be configured to compute a respective fused face token 64 corresponding to each of the face patch tokens 36 and a respective fused text token 62 corresponding to each of the text tokens 26. The one or more processing devices 12 are further configured to use the fused text tokens 62 and fused face tokens 64 to compute the face-augmented text tokens 46A and the text-augmented face tokens 46B as discussed above with reference to FIG. 2.

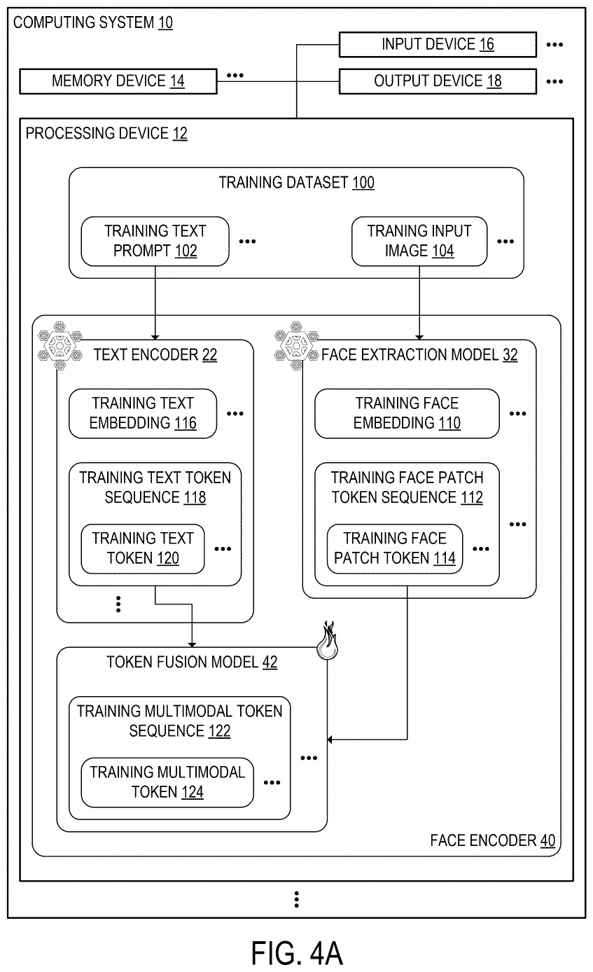

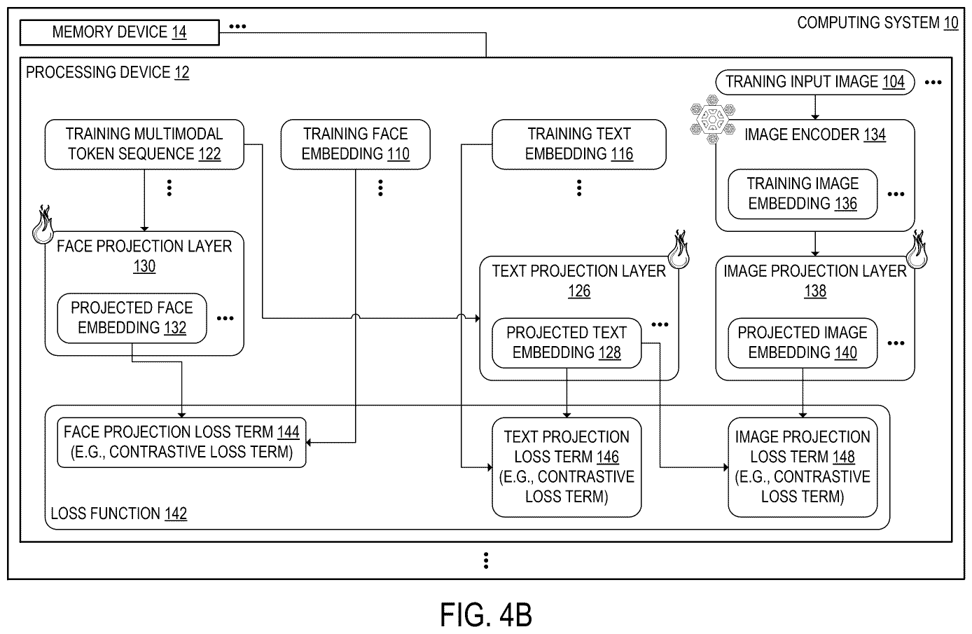

FIGS. 4A-4B schematically show the computing system 10 during training of the face encoder 40. When the one or more processing devices 12 train the face encoder 40, the weights of the token fusion model 42 are modified. In contrast, respective weights of the face extraction model 32 and the text encoder 22 are frozen during training of the token fusion model 42.

As shown in FIG. 4A, the one or more processing devices 12 are configured to receive a training dataset 100 that includes a plurality of training text prompts 102 and a corresponding plurality of training input images 104. The training input images 104 are paired with the training text prompts 102 to form respective text-image pairs. In some examples, the plurality of text-image pairs may include a plurality of positive example pairs and a plurality of negative example pairs. Each of the training input images 104 depicts a respective training face.

The one or more processing devices 12 are further configured to compute a plurality of training multimodal token sequences 122 at the token fusion model 42 based at least in part on the training text prompts 102 and the training input images 104. Each of the training multimodal token sequences 122 includes a plurality of training multimodal tokens 124.

During computation of the training multimodal token sequences 122, the one or more processing devices 12 are configured to compute a plurality of training text embeddings 116 at the text encoder 22 based at least in part on the training text prompts 102. The one or more processing devices 12 are further configured to compute a respective plurality of training text token sequences 118. Each of the training text token sequences 118 includes one or more training text tokens 120.

During computation of the training multimodal token sequences 122, the one or more processing devices 12 are further configured to compute a plurality of training face embeddings 110 at the face extraction model 32 based at least in part on the training input images 104. The one or more processing devices 12 are further configured to compute a respective plurality of training face patch token sequences 112. Each of the training face patch token sequences 112 includes a plurality of training face patch tokens 114.

The one or more processing devices 12 are further configured to compute the training multimodal token sequences 122 at the token fusion model 42 using the training text token sequences 118 and the training face patch token sequences 112 as input, according to the techniques discussed above with reference to FIGS. 2-3.

As shown in FIG. 4B, the one or more processing devices 12 are further configured to train the token fusion model 42 based at least in part on the training multimodal token sequences 122. This training further utilizes the training face embeddings 110 computed at the face extraction model 32 and the training text embeddings 116 computed at the text encoder 22. This training is performed using a loss function 142 that includes a face projection loss term 144, a text projection loss term 146, and an image projection loss term 148. For example, the face projection loss term 144, the text projection loss term 146, and the image projection loss term 148 may be contrastive loss terms. In such examples, the one or more processing devices 12 may be configured to train the token fusion model 42 such that the training inputs included in positive example pairs have similar embeddings and the training inputs included in negative example pairs have dissimilar embeddings.

During the training of the token fusion model 42, the one or more processing devices 12 are configured to execute a face projection layer 130. The face projection layer 130 may, for example, be a linear layer. At the face projection layer 130, the one or more processing devices 12 are configured to compute a plurality of projected face embeddings 132 based at least in part on respective training multimodal token sequences 122 of the plurality of training multimodal token sequences 122. The projected face embeddings 132 are projections of the training multimodal token sequences 122 into the embedding space of the face extraction model 32. The one or more processing devices 12 are further configured to compute the face projection loss term 144 based at least in part on the projected face embeddings 132 and the training face embeddings 110.

The one or more processing devices 12 are further configured to execute a text projection layer 126 during the training of the token fusion model 42. The text projection layer 126 may, for example, be a linear layer. At the text projection layer 126, the one or more processing devices 12 are configured to compute a plurality of projected text embeddings 128 based at least in part on respective training multimodal token sequences 122 of the plurality of training multimodal token sequences 122. The projected text embeddings 128 are projections of the training multimodal token sequences 122 into the embedding space of the text encoder 22. The one or more processing devices 12 are further configured to compute the text projection loss term 146 based at least in part on the projected text embeddings 128 and the training text embeddings 116.

The one or more processing devices 12 are further configured to compute a respective plurality of training image embeddings 136 at an image encoder 134 based at least in part on the training input images 104. The image encoder 134 is a pretrained image encoder with weights that are frozen during the training of the token fusion model 42. For example, the image encoder 134 may be a ViT model.

The one or more processing devices 12 are further configured to compute a plurality of projected image embeddings 140 at an image projection layer 138 based at least in part on the training image embeddings 136. The image projection layer 138 may be a linear layer. The projected image embeddings 140 are projections of the training image embeddings 136 into the embedding space of the text encoder 22. The one or more processing devices 12 are further configured to compute the image projection loss term 148 based at least in part on the projected image embeddings 140 and the projected text embeddings 128.

The one or more processing devices 12 are further configured to train the token fusion model 42 using the computed values of the loss function 142 by performing gradient descent with respect to the weights of the token fusion model 42. The face projection loss term 144 trains the token fusion model 42 to align the training multimodal token sequences 122 with the face embedding space of the face extraction model 32, the text projection loss term 146 trains the token fusion model 42 to align the training multimodal token sequences 122 with the text embedding space of the text encoder 22, and the image projection loss term 148 the token fusion model 42 to align the training multimodal token sequences 122 with the image embedding space of the image encoder 134. By aligning the outputs of the token fusion model 42 with the respective embedding spaces of the face extraction model 32, the text encoder 22, and the image encoder 134, the one or more processing devices 12 are configured to train the token fusion model 42 to map text tokens 26 and face patch tokens 36 into a shared embedding space.

In the example of FIG. 4B, the respective weights of the text projection layer 126, the face projection layer 130, and the image projection layer 138 are also modified during the training of the token fusion model 42. However, the text projection layer 126, the face projection layer 130, and the image projection layer 138 are not utilized at inferencing time in the example of FIG. 4B. The weights of the image encoder 134 are frozen in this example, and the image encoder 134 is also not utilized at inferencing time.

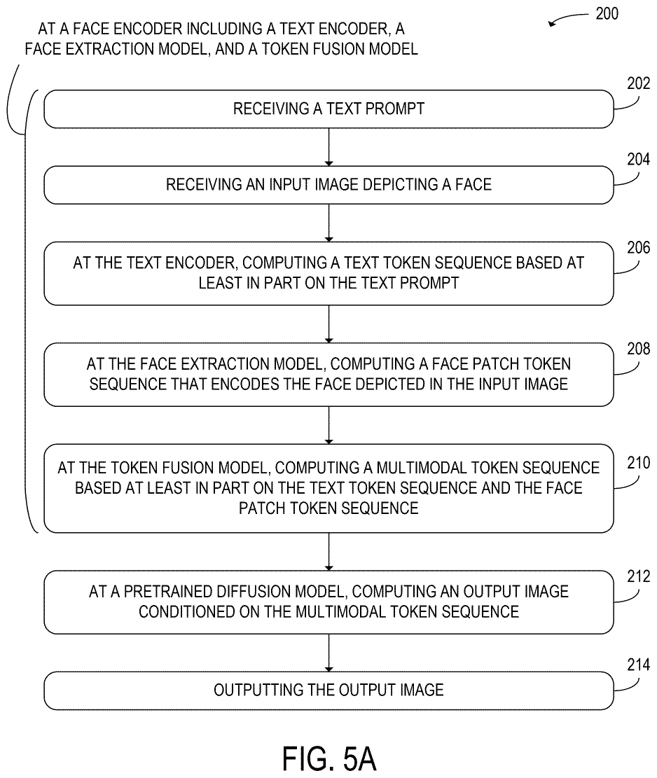

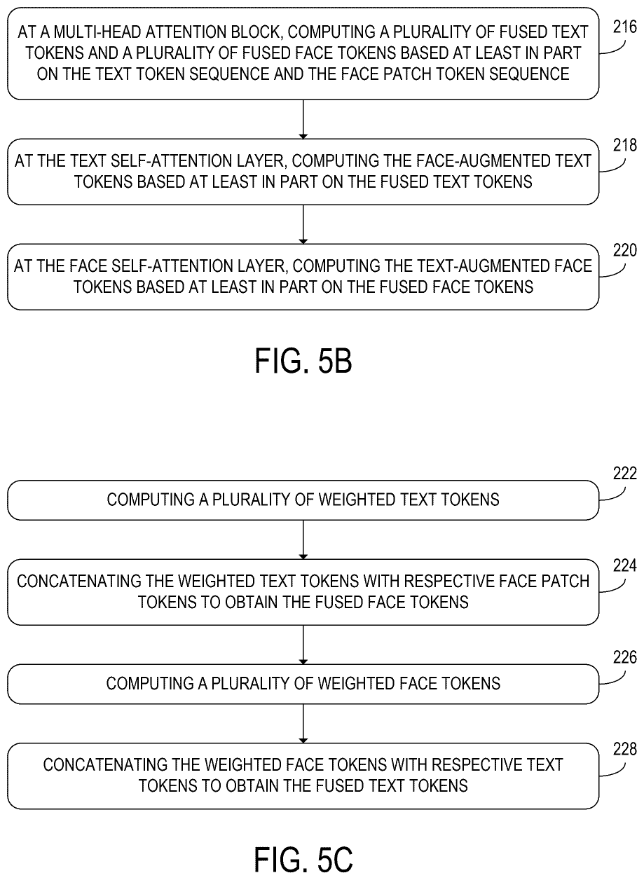

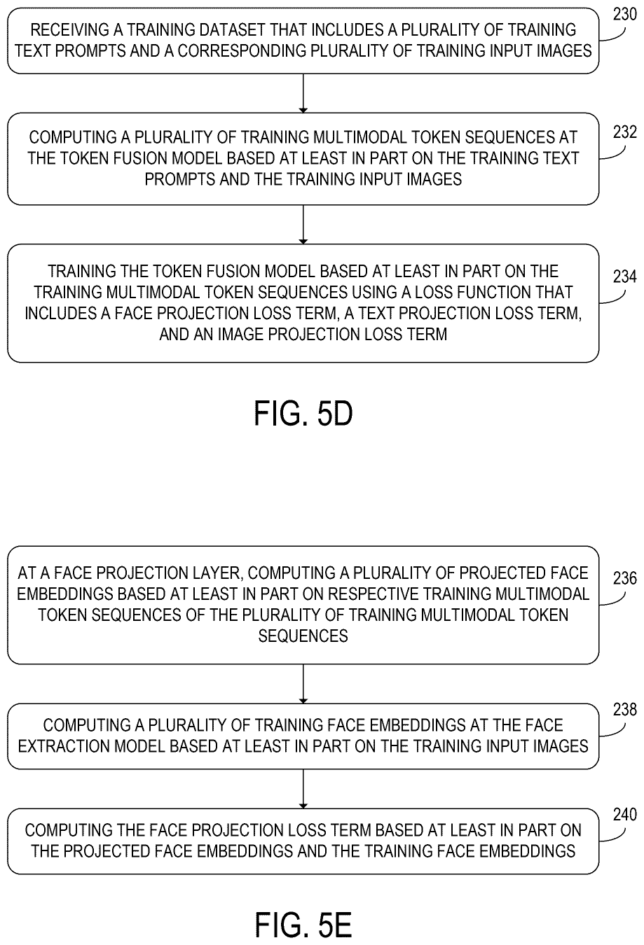

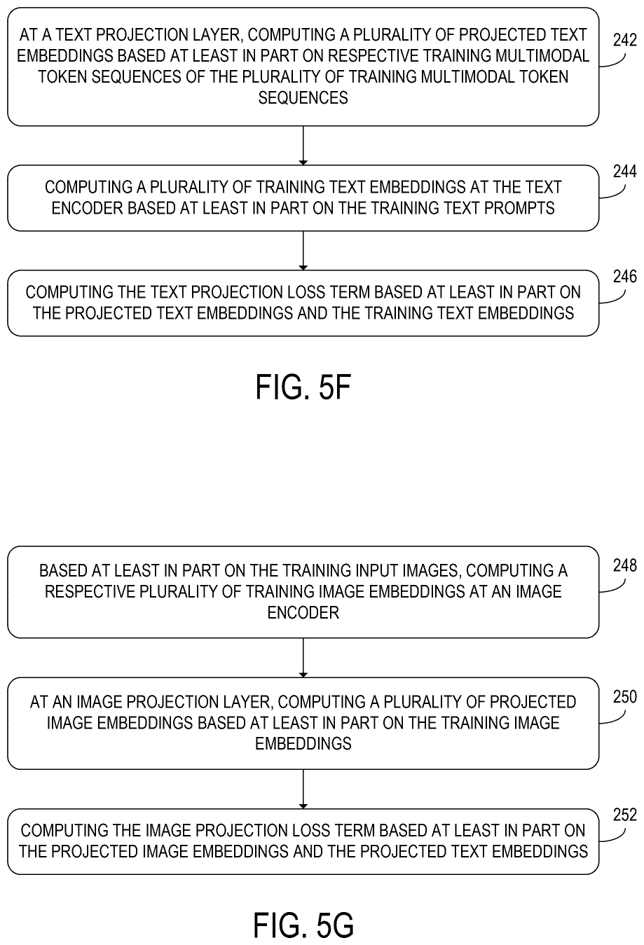

FIG. 5A shows a flowchart of a method 200 for use with a computing system to perform image-conditioned T2I generation. The method 200 includes steps 202, 204, 206, 208, and 210, which are performed at a face encoder. The face encoder includes a text encoder, a face extraction model, and a token fusion model. At step 202, the method 200 includes receiving a text prompt. At step 204, the method 200 further includes receiving an input image depicting a face.

At step 206, the method 200 further includes computing a text token sequence at the text encoder based at least in part on the text prompt. The text token sequence includes a plurality of text tokens. At step 208, the method 200 further includes computing a face patch token sequence at the face extraction model. The face patch token sequence includes a plurality of face patch tokens and encodes the face depicted in the input image.

At step 210, the method 200 further includes computing a multimodal token sequence at the token fusion model. The multimodal token sequence includes a plurality of multimodal tokens and is computed based at least in part on the text token sequence and the face patch token sequence. The multimodal tokens encode both the instructions included in the text prompt and the facial features of the face depicted in the input image. In some examples, the multimodal token sequence includes a plurality of face-augmented text tokens and a plurality of text-augmented face tokens.

At step 212, the method 200 further includes computing an output image conditioned on the multimodal token sequence at a pretrained diffusion model. The pretrained diffusion model initializes the output image as a noised image and performs a plurality of denoising iterations conditioned on the multimodal token sequence. At step 214, the method 200 further includes outputting the output image. The output image may be output to a GUI for display to a user.

FIGS. 5B-5G show additional steps of the method 200 that may be performed in some examples. FIG. 5B shows steps that may be performed at the token fusion model. In the example of FIG. 5B, the token fusion model includes a multi-head attention block, a text self-attention layer, and a face self-attention layer. At step 216, the method 200 may further include computing a plurality of fused text tokens and a plurality of fused face tokens at the multi-head attention block. The multi-head attention block may compute the fused text tokens and the fused face tokens based at least in part on the text token sequence and the face patch token sequence.

The multimodal token sequence includes face-augmented text tokens and text-augmented face tokens in the example of FIG. 5B. At step 218, the method 200 may further include computing the face-augmented text tokens at the text self-attention layer. The face-augmented text tokens may be computed based at least in part on the fused text tokens. In addition, at step 220, the method 200 may further include computing the text-augmented face tokens at the face self-attention layer. The text-augmented face tokens may be computed based at least in part on the fused face tokens.

FIG. 5C shows additional steps of the method 200 that may be performed in some examples when computing the fused text tokens and the fused face tokens at the multi-head attention block during step 216. At step 222, the method 200 may further include computing a plurality of weighted text tokens. The weighted text tokens may each be computed at least in part by passing a text token and a face patch token through a first linear layer and a second linear layer, respectively, computing an attention weight matrix over the outputs of the first and second linear layers, passing the text token through a third linear layer, and performing matrix multiplication between the attention weight matrix and the output of the third linear layer. At step 224, the method 200 may further include concatenating the weighted text tokens with respective face patch tokens to obtain the fused face tokens.

At step 226, the method 200 may further include computing a plurality of weighted face tokens. The weighted face tokens may each be computed at least in part by transposing the attention weight matrix, passing the face patch token through a fourth linear layer, and performing matrix multiplication between the attention weight matrix and the output of the fourth linear layer. At step 228, the method 200 may further include concatenating the weighted face tokens with respective text tokens to obtain the fused text tokens. Accordingly, the outputs of the multi-head attention block are computed.

FIG. 5D shows additional steps of the method 200 that may be performed to train the token fusion model included in the face encoder. At step 230, the method 200 may further include receiving a training dataset that includes a plurality of training text prompts and a corresponding plurality of training input images. The training input images are paired with corresponding training text prompts and depict respective training faces.

At step 232, the method 200 may further include computing a plurality of training multimodal token sequences at the token fusion model based at least in part on the training text prompts and the training input images. Computing the training multimodal token sequences may include computing a plurality of training text token sequences at the text encoder based at least in part on the training text prompts and computing a plurality of training face patch token sequences at the face extraction model based at least in part on the training input images. The training multimodal token sequences may be computed at the token fusion model based at least in part on the training text token sequences and the training face patch token sequences.

At step 234, the method 200 may further include training the token fusion model based at least in part on the training multimodal token sequences using a loss function that includes a face projection loss term, a text projection loss term, and an image projection loss term. For example, the face projection loss term, the text projection loss term, and the image projection loss term may be contrastive loss terms. Respective weights of the face extraction model and the text encoder may be frozen during training of the token fusion model.

FIG. 5E shows additional steps of the method 200 that may be performed in the example of FIG. 5D in order to compute the face projection loss term. At step 236, the method 200 may further include computing a plurality of projected face embeddings at a face projection layer. The projected face embeddings may be computed based at least in part on respective training multimodal token sequences of the plurality of training multimodal token sequences.

At step 238, the method 200 may further include computing a plurality of training face embeddings at the face extraction model based at least in part on the training input images. The training face embeddings may be computed in addition to the training face patch token sequences. At step 240, the method 200 may further include computing the face projection loss term based at least in part on the projected face embeddings and the training face embeddings.

FIG. 5F shows additional steps of the method 200 that may be performed in the example of FIG. 5D in order to compute the text projection loss term. At step 242, the method 200 may further include computing a plurality of projected text embeddings at a text projection layer. The projected text embeddings may be computed based at least in part on respective training multimodal token sequences of the plurality of training multimodal token sequences.

At step 244, the method 200 may further include computing a plurality of training text embeddings at the text encoder based at least in part on the training text prompts. The training text embeddings may be computed in addition to the training text token sequences. At step 246, the method 200 may further include computing the text projection loss term based at least in part on the projected text embeddings and the training text embeddings.

FIG. 5G shows additional steps of the method 200 that may be performed in the example of FIG. 5D in order to compute the image projection loss term. At step 248, the method 200 may include computing a respective plurality of training image embeddings at an image encoder based at least in part on the training input images. The image encoder may be a pretrained image encoder.

At step 250, the method 200 may further include computing a plurality of projected image embeddings at an image projection layer. The projected image embeddings may be computed based at least in part on the training image embeddings. At step 252, the method 200 may further include computing the image projection loss term based at least in part on the projected image embeddings and the projected text embeddings.

Using the systems and methods discussed above, a multimodal token sequence is used to guide denoising during reference-image-conditioned T2I generation of images that depict faces. The multimodal token sequence is computed at a face encoder, and combines the features included in text tokens with the features included in face patch tokens. The diffusion model that generates the output image may therefore preserve recognizability of an individual depicted in the reference image while also adhering to the instructions included in the text prompt.

The methods and processes described herein are tied to a computing system of one or more computing devices. In particular, such methods and processes can be implemented as a computer-application program or service, an application-programming interface (API), a library, and/or other computer-program product.

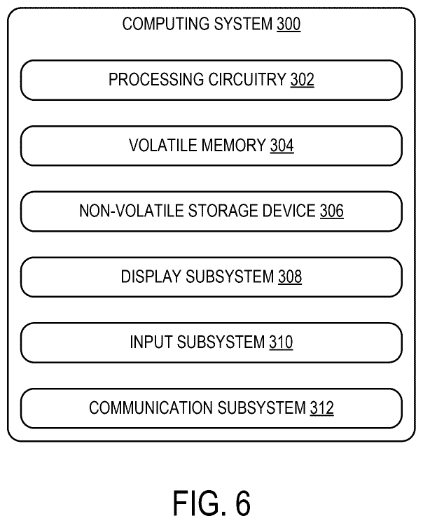

FIG. 6 schematically shows a non-limiting embodiment of a computing system 300 that can enact one or more of the methods and processes described above. Computing system 300 is shown in simplified form and may instantiate the computing system 10 depicted in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory 304, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive a text prompt at a face encoder including a text encoder, a face extraction model, and a token fusion model. At the face encoder, the one or more processing devices are further configured to receive an input image depicting a face. At the text encoder, the one or more processing devices are further configured to compute a text token sequence based at least in part on the text prompt. At the face extraction model, the one or more processing devices are further configured to compute a face patch token sequence that encodes the face depicted in the input image. At the token fusion model, the one or more processing devices are further configured to compute a multimodal token sequence based at least in part on the text token sequence and the face patch token sequence. At a pretrained diffusion model, the one or more processing devices are further configured to compute an output image conditioned on the multimodal token sequence. The one or more processing devices are further configured to output the output image. The above features may have the technical effect of combining the text tokens with the face patch tokens in the inputs of the pretrained diffusion model to preserve facial recognizability while also achieving high prompt adherence.

According to this aspect, the multimodal token sequence may include a plurality of face-augmented text tokens and a plurality of text-augmented face tokens. The above features may have the technical effect of incorporating both the face and text data into the multimodal token sequence.

According to this aspect, the token fusion model may include a multi-head attention block at which the one or more processing devices are configured to compute a plurality of fused text tokens and a plurality of fused face tokens based at least in part on the text token sequence and the face patch token sequence. The token fusion model may further include a text self-attention layer at which the one or more processing devices are configured to compute the face-augmented text tokens based at least in part on the fused text tokens. The token fusion model may further include a face self-attention layer at which the one or more processing devices are configured to compute the text-augmented face tokens based at least in part on the fused face tokens. The above features may have the technical effect of using multi-head attention and self-attention to combine the face data and text data when computing the multimodal token sequence.

According to this aspect, at the multi-head attention block, the one or more processing devices may be configured to compute a plurality of weighted text tokens and concatenate the weighted text tokens with respective face patch tokens to obtain the fused face tokens. The one or more processing devices may be further configured to compute a plurality of weighted face tokens and concatenate the weighted face tokens with respective text tokens to obtain the fused text tokens. The above features may have the technical effect of incorporating the original text tokens and face patch tokens into the multimodal tokens.

According to this aspect, the one or more processing devices may be further configured to receive a training dataset that includes a plurality of training text prompts and a corresponding plurality of training input images. The one or more processing devices may be further configured to compute a plurality of training multimodal token sequences at the token fusion model based at least in part on the training text prompts and the training input images. The one or more processing devices may be further configured to train the token fusion model based at least in part on the training multimodal token sequences using a loss function that includes a face projection loss term, a text projection loss term, and an image projection loss term. The above features may have the technical effect of training the token fusion model.

According to this aspect, during the training of the token fusion model, the one or more processing devices may be further configured to compute a plurality of projected face embeddings at a face projection layer based at least in part on respective training multimodal token sequences of the plurality of training multimodal token sequences. The one or more processing devices may be further configured to compute a plurality of training face embeddings at the face extraction model based at least in part on the training input images. The one or more processing devices may be further configured to compute the face projection loss term based at least in part on the projected face embeddings and the training face embeddings. The above features may have the technical effect of training the token fusion model to align the multimodal token sequences with the face embedding space of the face extraction model.

According to this aspect, during the training of the token fusion model, the one or more processing devices may be further configured to compute a plurality of projected text embeddings at a text projection layer based at least in part on respective training multimodal token sequences of the plurality of training multimodal token sequences. The one or more processing devices may be further configured to compute a plurality of training text embeddings at the text encoder based at least in part on the training text prompts. The one or more processing devices may be further configured to compute the text projection loss term based at least in part on the projected text embeddings and the training text embeddings. The above features may have the technical effect of training the token fusion model to align the multimodal token sequences with the text embedding space of the text encoder.

According to this aspect, during the training of the token fusion model, the one or more processing devices may be further configured to compute a respective plurality of training image embeddings at an image encoder based at least in part on the training input images. At an image projection layer, the one or more processing devices may be further configured to compute a plurality of projected image embeddings based at least in part on the training image embeddings. The one or more processing devices may be further configured to compute the image projection loss term based at least in part on the projected image embeddings and the projected text embeddings. The above features may have the technical effect of training the token fusion model to align the multimodal token sequences with the image embedding space of the image encoder.

According to this aspect, the face projection loss term, the text projection loss term, and the image projection loss term may be contrastive loss terms. The above features may have the technical effect of training the token fusion model such that the training inputs included in positive example pairs have similar embeddings and the training inputs included in negative example pairs have dissimilar embeddings.

According to this aspect, respective weights of the face extraction model and the text encoder are frozen during training of the token fusion model. The above features may have the technical effect of preserving the pretrained capabilities of the face extraction model and the text encoder during training of the token fusion model.

According to another aspect of the present disclosure, a method for use with a computing system is provided. The method includes receiving a text prompt at a face encoder including a text encoder, a face extraction model, and a token fusion model. The method further includes receiving an input image depicting a face. At the text encoder, the method further includes computing a text token sequence based at least in part on the text prompt. At the face extraction model, the method further includes computing a face patch token sequence that encodes the face depicted in the input image. At the token fusion model, the method further includes computing a multimodal token sequence based at least in part on the text token sequence and the face patch token sequence. At a pretrained diffusion model, the method further includes computing an output image conditioned on the multimodal token sequence. The method further includes outputting the output image. The above features may have the technical effect of combining the text tokens with the face patch tokens in the inputs of the pretrained diffusion model to preserve facial recognizability while also achieving high prompt adherence.

According to this aspect, the multimodal token sequence may include a plurality of face-augmented text tokens and a plurality of text-augmented face tokens. The above features may have the technical effect of incorporating both the face and text data into the multimodal token sequence.

According to this aspect, the token fusion model may include a multi-head attention block, a text self-attention layer, and a face self-attention layer. At the multi-head attention block, the method may further include computing a plurality of fused text tokens and a plurality of fused face tokens based at least in part on the text token sequence and the face patch token sequence. At the text self-attention layer, the method may further include computing the face-augmented text tokens based at least in part on the fused text tokens. At the face self-attention layer, the method may further include computing the text-augmented face tokens based at least in part on the fused face tokens. The above features may have the technical effect of using multi-head attention and self-attention to combine the face data and text data when computing the multimodal token sequence.

According to this aspect, the method may further include, at the multi-head attention block, computing a plurality of weighted text tokens and concatenating the weighted text tokens with respective face patch tokens to obtain the fused face tokens. The method may further include computing a plurality of weighted face tokens and concatenating the weighted face tokens with respective text tokens to obtain the fused text tokens. The above features may have the technical effect of incorporating the original text tokens and face patch tokens into the multimodal tokens.

According to this aspect, the method may further include receiving a training dataset that includes a plurality of training text prompts and a corresponding plurality of training input images. The method may further include computing a plurality of training multimodal token sequences at the token fusion model based at least in part on the training text prompts and the training input images. The method may further include training the token fusion model based at least in part on the training multimodal token sequences using a loss function that includes a face projection loss term, a text projection loss term, and an image projection loss term. The above features may have the technical effect of training the token fusion model.

According to this aspect, during the training of the token fusion model, the method may further include, at a face projection layer, computing a plurality of projected face embeddings based at least in part on respective training multimodal token sequences of the plurality of training multimodal token sequences. The method may further include computing a plurality of training face embeddings at the face extraction model based at least in part on the training input images. The method may further include computing the face projection loss term based at least in part on the projected face embeddings and the training face embeddings. The above features may have the technical effect of training the token fusion model to align the multimodal token sequences with the face embedding space of the face extraction model.

According to this aspect, during the training of the token fusion model, the method may further include, at a text projection layer, computing a plurality of projected text embeddings based at least in part on respective training multimodal token sequences of the plurality of training multimodal token sequences. The method may further include computing a plurality of training text embeddings at the text encoder based at least in part on the training text prompts. The method may further include computing the text projection loss term based at least in part on the projected text embeddings and the training text embeddings. The above features may have the technical effect of training the token fusion model to align the multimodal token sequences with the text embedding space of the text encoder.

According to this aspect, during the training of the token fusion model, the method may further include computing a respective plurality of training image embeddings at an image encoder based at least in part on the training input images. At an image projection layer, the method may further include computing a plurality of projected image embeddings based at least in part on the training image embeddings. The method may further include computing the image projection loss term based at least in part on the projected image embeddings and the projected text embeddings. The above features may have the technical effect of training the token fusion model to align the multimodal token sequences with the image embedding space of the image encoder.

According to this aspect, the face projection loss term, the text projection loss term, and the image projection loss term may be contrastive loss terms. The above features may have the technical effect of training the token fusion model such that the training inputs included in positive example pairs have similar embeddings and the training inputs included in negative example pairs have dissimilar embeddings.

According to another aspect of the present disclosure, a computing system is provided, including one or more processing devices configured to receive a training dataset that includes a plurality of training text prompts and a corresponding plurality of training input images. The training input images depict respective training faces. At a face encoder including a text encoder, a face extraction model, and a token fusion model, the one or more processing devices are further configured to compute a plurality of training text embeddings and a plurality of training text token sequences at the text encoder based at least in part on the training text prompts. The one or more processing devices are further configured to compute a plurality of training face embeddings a plurality of training face patch token sequences at the face extraction model based at least in part on the training input images. The one or more processing devices are further configured to compute a plurality of training multimodal token sequences at the token fusion model based at least in part on the training text token sequences and the training face patch token sequences. Based at least in part on the training input images, the one or more processing devices are further configured to compute a respective plurality of training image embeddings at an image encoder. The one or more processing devices are further configured to compute a loss function based at least in part on the training text embeddings, the training face embeddings, the training multimodal tokens sequences, and the training image embeddings. The one or more processing devices are further configured to train the token fusion model using the loss function. At the face encoder, the one or more processing devices are further configured to receive a text prompt, receive an input image depicting a face, and compute a multimodal token sequence based at least in part on the text prompt and the input image. At a pretrained diffusion model, the one or more processing devices are further configured to compute an output image conditioned on the multimodal token sequence. The one or more processing devices are further configured to output the output image. The above features may have the technical effect of combining the text tokens with the face patch tokens in the inputs of the pretrained diffusion model to preserve facial recognizability while also achieving high prompt adherence.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
at a face encoder including a text encoder, a face extraction model, and a token fusion model:
receive a text prompt;
receive an input image depicting a face;
at the text encoder, compute a text token sequence based at least in part on the text prompt;
at the face extraction model, compute a face patch token sequence that encodes the face depicted in the input image; and
at the token fusion model, compute a multimodal token sequence based at least in part on the text token sequence and the face patch token sequence;
at a pretrained diffusion model, compute an output image conditioned on the multimodal token sequence; and
output the output image.

2. The computing system of claim 1, wherein the multimodal token sequence includes:
a plurality of face-augmented text tokens; and
a plurality of text-augmented face tokens.

3. The computing system of claim 2, wherein the token fusion model includes:
a multi-head attention block at which the one or more processing devices are configured to compute a plurality of fused text tokens and a plurality of fused face tokens based at least in part on the text token sequence and the face patch token sequence;
a text self-attention layer at which the one or more processing devices are configured to compute the face-augmented text tokens based at least in part on the fused text tokens; and
a face self-attention layer at which the one or more processing devices are configured to compute the text-augmented face tokens based at least in part on the fused face tokens.

4. The computing system of claim 3, wherein, at the multi-head attention block, the one or more processing devices are configured to:
compute a plurality of weighted text tokens;
concatenate the weighted text tokens with respective face patch tokens to obtain the fused face tokens;
compute a plurality of weighted face tokens; and
concatenate the weighted face tokens with respective text tokens to obtain the fused text tokens.

5. The computing system of claim 1, wherein the one or more processing devices are further configured to:
receive a training dataset that includes a plurality of training text prompts and a corresponding plurality of training input images;
compute a plurality of training multimodal token sequences at the token fusion model based at least in part on the training text prompts and the training input images; and
train the token fusion model based at least in part on the training multimodal token sequences using a loss function that includes a face projection loss term, a text projection loss term, and an image projection loss term.

6. The computing system of claim 5, wherein, during the training of the token fusion model, the one or more processing devices are further configured to:
at a face projection layer, compute a plurality of projected face embeddings based at least in part on respective training multimodal token sequences of the plurality of training multimodal token sequences;
compute a plurality of training face embeddings at the face extraction model based at least in part on the training input images; and
compute the face projection loss term based at least in part on the projected face embeddings and the training face embeddings.

7. The computing system of claim 5, wherein, during the training of the token fusion model, the one or more processing devices are further configured to:
at a text projection layer, compute a plurality of projected text embeddings based at least in part on respective training multimodal token sequences of the plurality of training multimodal token sequences;
compute a plurality of training text embeddings at the text encoder based at least in part on the training text prompts; and
compute the text projection loss term based at least in part on the projected text embeddings and the training text embeddings.

8. The computing system of claim 7, wherein, during the training of the token fusion model, the one or more processing devices are further configured to:
based at least in part on the training input images, compute a respective plurality of training image embeddings at an image encoder;
at an image projection layer, compute a plurality of projected image embeddings based at least in part on the training image embeddings; and
compute the image projection loss term based at least in part on the projected image embeddings and the projected text embeddings.

9. The computing system of claim 5, wherein the face projection loss term, the text projection loss term, and the image projection loss term are contrastive loss terms.

10. The computing system of claim 5, wherein respective weights of the face extraction model and the text encoder are frozen during training of the token fusion model.

11. A method for use with a computing system, the method comprising:
at a face encoder including a text encoder, a face extraction model, and a token fusion model:
receiving a text prompt;
receiving an input image depicting a face;
at the text encoder, computing a text token sequence based at least in part on the text prompt;
at the face extraction model, computing a face patch token sequence that encodes the face depicted in the input image; and
at the token fusion model, computing a multimodal token sequence based at least in part on the text token sequence and the face patch token sequence;
at a pretrained diffusion model, computing an output image conditioned on the multimodal token sequence; and
outputting the output image.

12. The method of claim 11, wherein the multimodal token sequence includes:
a plurality of face-augmented text tokens; and
a plurality of text-augmented face tokens.

13. The method of claim 12, wherein:
the token fusion model includes a multi-head attention block, a text self-attention layer, and a face self-attention layer; and
the method further comprises:
at the multi-head attention block, computing a plurality of fused text tokens and a plurality of fused face tokens based at least in part on the text token sequence and the face patch token sequence;
at the text self-attention layer, computing the face-augmented text tokens based at least in part on the fused text tokens; and
at the face self-attention layer, computing the text-augmented face tokens based at least in part on the fused face tokens.

14. The method of claim 13, further comprising, at the multi-head attention block:
computing a plurality of weighted text tokens;
concatenating the weighted text tokens with respective face patch tokens to obtain the fused face tokens;
computing a plurality of weighted face tokens; and
concatenating the weighted face tokens with respective text tokens to obtain the fused text tokens.

15. The method of claim 11, further comprising:
receiving a training dataset that includes a plurality of training text prompts and a corresponding plurality of training input images;
computing a plurality of training multimodal token sequences at the token fusion model based at least in part on the training text prompts and the training input images; and
training the token fusion model based at least in part on the training multimodal token sequences using a loss function that includes a face projection loss term, a text projection loss term, and an image projection loss term.

16. The method of claim 15, further comprising, during the training of the token fusion model:
at a face projection layer, computing a plurality of projected face embeddings based at least in part on respective training multimodal token sequences of the plurality of training multimodal token sequences;
computing a plurality of training face embeddings at the face extraction model based at least in part on the training input images; and
computing the face projection loss term based at least in part on the projected face embeddings and the training face embeddings.

17. The method of claim 15, further comprising, during the training of the token fusion model:
at a text projection layer, computing a plurality of projected text embeddings based at least in part on respective training multimodal token sequences of the plurality of training multimodal token sequences;
computing a plurality of training text embeddings at the text encoder based at least in part on the training text prompts; and
computing the text projection loss term based at least in part on the projected text embeddings and the training text embeddings.

18. The method of claim 17, further comprising, during the training of the token fusion model:
based at least in part on the training input images, computing a respective plurality of training image embeddings at an image encoder;
at an image projection layer, computing a plurality of projected image embeddings based at least in part on the training image embeddings; and
computing the image projection loss term based at least in part on the projected image embeddings and the projected text embeddings.

19. The method of claim 15, wherein the face projection loss term, the text projection loss term, and the image projection loss term are contrastive loss terms.

20. A computing system comprising:
one or more processing devices configured to:
receive a training dataset that includes a plurality of training text prompts and a corresponding plurality of training input images, wherein the training input images depict respective training faces;
at a face encoder including a text encoder, a face extraction model, and a token fusion model:
compute a plurality of training text embeddings and a plurality of training text token sequences at the text encoder based at least in part on the training text prompts;
compute a plurality of training face embeddings a plurality of training face patch token sequences at the face extraction model based at least in part on the training input images;
compute a plurality of training multimodal token sequences at the token fusion model based at least in part on the training text token sequences and the training face patch token sequences;
based at least in part on the training input images, compute a respective plurality of training image embeddings at an image encoder;
compute a loss function based at least in part on the training text embeddings, the training face embeddings, the training multimodal tokens sequences, and the training image embeddings;
train the token fusion model using the loss function;
at the face encoder:
receive a text prompt;
receive an input image depicting a face; and
compute a multimodal token sequence based at least in part on the text prompt and the input image;
at a pretrained diffusion model, compute an output image conditioned on the multimodal token sequence; and
output the output image.
